(19) United States
(12) Patent Application Publication
(10) Pub. No.: US 2021/0067751 A1
(43) Pub. Date: Mar. 4, 2021

(54) PROJECTOR LIGHT SOURCE MODULATION APPARATUS AND MODULATION METHOD

(71) Applicant: Panasonic Intellectual Property Management Co., Ltd., Osaka (JP)

(72) Inventor: Takaaki GYOTEN, Hyogo (JP)

(21) Appl. No.: 17/098,782

(22) Filed: Nov. 16, 2020

Related U.S. Application Data
(63) Continuation of application No. PCT/JP2019/007480, filed on Feb. 27, 2019.

(30) Foreign Application Priority Data
May 17, 2018 (JP) 2018-095669

(51) Int. Cl. H04N 9/31; H04B 10/50; H04N 5/067

(52) U.S. Cl. CPC H04N 9/3161; H04N 5/067; H04B 10/505

(57) ABSTRACT

A projector light source modulation apparatus is provided, which includes a semiconductor laser driver circuit, that drives a semiconductor laser according to a second control signal generated based on a timing signal and a communication modulation code; a wavelength converter element, that converts a wavelength of output light from a semiconductor laser, and outputs a converted light; a light modulator element, that modulates the light outputted from the wavelength converter element according to a first control signal, and outputs a modulated light; and a projection lens that projects the modulated light from the light modulator element. Subframes are provided multiple times and arranged temporally at equal intervals for one interval of the vertical synchronization signal, each of the subframes turning on the light modulator element continuously for a superimposition interval of superimposing the communication modulation signal.

### CROSS-REFERENCE TO RELATED APPLICATION

This is a continuation application based on PCT application No. PCT/JP2019/007480 as filed on Feb. 27, 2019, which claims priority to Japanese patent application No. JP2018-095669 as filed May 17, 2018, the content of which is incorporated herein by reference.

### BACKGROUND OF THE DISCLOSURE

### 1. Field of the Disclosure

The present disclosure relates to a projector light source modulation apparatus, and a modulation method.

### 2. Description of Related Art

Japanese patent No. JP5608834B1 discloses a video display method of superimposing information on a video display apparatus that performs luminance modulation using a plurality of subframes. In this video display method, at least one subframe among a plurality of subframes whose luminance is modulated to be turned on and off so that the information is superimposed on the at least one subframe, and then, the luminance in the subframe is set to a value obtaining by considering a decrease in the luminance, by superimposing the information. This can correct the change in the luminance of the subframe caused by superimposing the information, and obtain a video display method that achieves preferable gradation expression.

However, there is such a problem of occurrence of flicker that humans feel in video displayed by superimposing the information.

### SUMMARY OF THE DISCLOSURE

The object of the present disclosure is to provide a projector light source modulation apparatus that can superimpose information on projected video without generating any flicker that humans feel.

According to one aspect of the present disclosure, there is provided a projector light source modulation apparatus, which includes a modulation signal generator circuit, that generates a first control signal for controlling light to be turned on and off, and a timing signal indicating a timing of superimposing a communication modulation signal on the video signal, based on a video signal and a vertical synchronization signal. The projector light source modulation apparatus further includes a communication modulator, a semiconductor laser, a semiconductor laser driver circuit, a wavelength converter element, a light modulator element, and a projection lens. The communication modulator generates a second control signal for controlling a light source to be turned on and off based on the timing signal and a communication modulation code, and the semiconductor laser generates output light. The semiconductor laser driver circuit drives the semiconductor laser according to the second control signal, and the wavelength converter element converts a wavelength of the output light from the semiconductor laser, and outputs a converted light. The light modulator element modulates the light outputted from the wavelength converter element according to the first control signal, and outputs a modulated light, and the projection lens projects the modulated light from the light modulator element. Subframes are provided multiple times and arranged temporally at equal intervals for one interval of the vertical synchronization signal, each of the subframes turning on the light modulator element continuously for a superimposition interval of superimposing the communication modulation signal.

Therefore, according to the projector light source modulation apparatus of the present disclosure, it is possible to superimpose information on the projected video without generating any flicker that humans feel.

### BRIEF DESCRIPTION OF THE DRAWINGS

FIG. 1 is a block diagram showing a configuration example of a projector light source modulation apparatus according to an embodiment.

FIG. 2 is a timing chart of respective signals showing an operation example of the projector light source modulation apparatus of FIG. 1.

### DETAILED DESCRIPTION OF THE DISCLOSURE

Hereinafter, embodiments are described in detail with reference to the drawings as appropriate. However, unnecessarily detailed descriptions may be omitted. For example, detailed descriptions of well-known items or redundant descriptions of substantially the same configurations may be omitted. This is to prevent the following description from being unnecessarily redundant and to facilitate understanding by those skilled in the art.

It should be noted that the inventor provides the accompanying drawings and the following description for those skilled in the art to fully understand the present disclosure, and is not intended to limit the subject matter described in the claims by these.

### First Embodiment

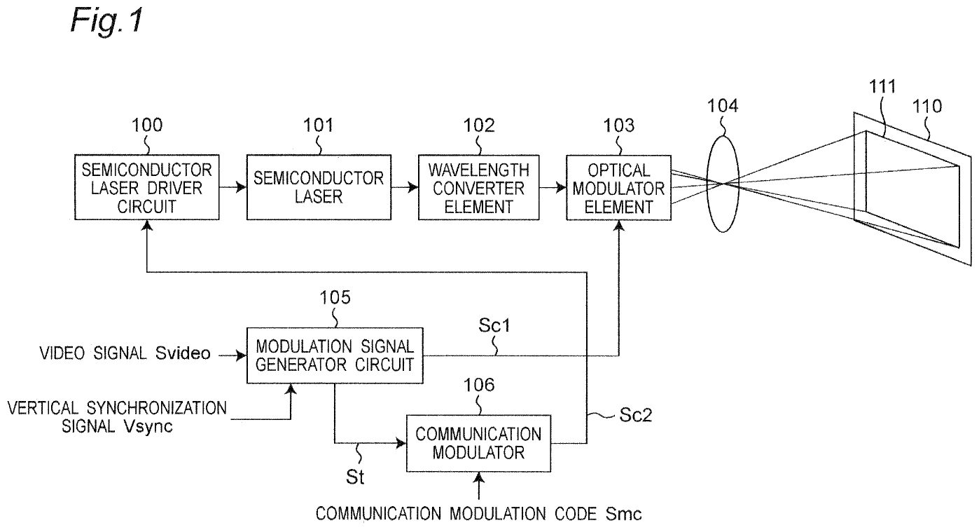

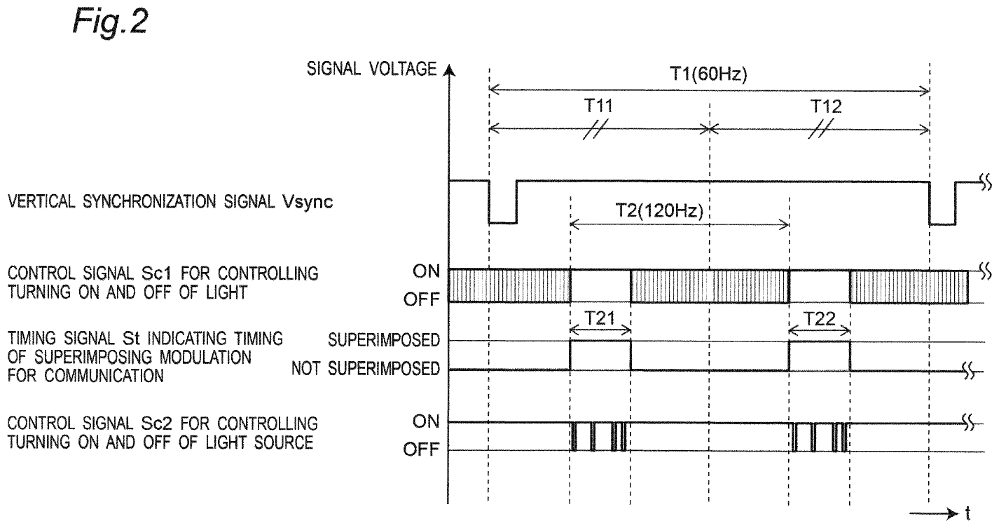

The first embodiment is described below with reference to FIGS. 1 and 2. In this case, a projector light source modulation apparatus according to the present embodiment relates to a projector light source modulation apparatus that can associate video that a projector displays with information transmitted (for example, see FIG. 1 of JP5608834B1), by the following:

(A) superimposing the information on the projected video using light source luminance modulation of the projector that projects the video; and

(B) reading the information by an instrument such as a smartphone equipped with a camera that captures the video (with visible light communication).

### 1-1. Configuration of Projector Light Source Modulation Apparatus

FIG. 1 is a block diagram showing a configuration example of a projector light source modulation apparatus according to a first embodiment. Referring to FIG. 1, the projector light source modulation apparatus according to the first embodiment is configured to include a semiconductor laser driver circuit 100, a semiconductor laser 101, a wavelength converter element 102, a light modulator element 103, a projection lens 104, a modulation signal generator circuit 105, and a communication modulator 106.

The modulation signal generator circuit 105 receives a video signal Svideo and a vertical synchronization signal Vsinc as inputs, and generates a control signal Sc1 for controlling light to be turned on and off according to the video signal Svideo, and a timing signal St indicating the timing of superimposing a communication modulation signal on the video signal. In this case, the modulation signal generator circuit 105 outputs the control signal Sc1 to the light modulator element 103, and outputs the timing signal St to the communication modulator 106. The communication modulator 106 receives the timing signal St and a communication modulation code (communication modulation signal) Smc as inputs. At the timing indicated by the timing signal St, the communication modulator 106 generates a control signal Sc2 for controlling a light source to be turned on and off, according to the communication modulation code Smc, and outputs the control signal Sc2 to the semiconductor laser driver circuit 100.

The semiconductor laser driver circuit 100 receives the control signal Sc2 for controlling the light source to be turned on and off as an input. Then, the semiconductor laser driver circuit 100 drives the semiconductor laser 101 according to the control signal Sc2, to allow the semiconductor laser 101 to emit semiconductor laser light, and to allow the wavelength converter element 102 to output the semiconductor laser light. The wavelength converter element 102 converts the wavelength of the semiconductor laser light output from the semiconductor laser 101, and outputs a wavelength-converted semiconductor laser light to the light modulator element 103. The light modulator element 103 modulates the luminance (or modulates the intensity) of the output light from the wavelength converter element 102 in accordance with the control signal Sc1 for controlling the light to be turned on and off, and outputs the modulated light. The modulated light is projected onto a screen 110 via the projection lens 104, and a video 111 thereof is projected on the screen 110.

### 1-2. Operation

The operation of the projector light source modulation apparatus configured as above is described below.

FIG. 2 is a timing chart of respective signals showing an operation example of the projector light source modulation apparatus of FIG. 1. FIG. 2 shows the following signals:

(A) the vertical synchronization signal Vsync, which is inputted to the modulation signal generator circuit 105;

(B) the control signal Sc1 for controlling the light, which is generated by the modulation signal generator circuit 105 to be turned on and off, and is outputted to the light modulator element 103;

(C) the timing signal St indicating the timing of superimposing the communication modulation signal, which is generated by the modulation signal generator circuit 105 and is outputted to the communication modulator 106; and

(D) the control signal Sc2, which is generated by the communication modulator 106, where the control signal Sc2 is provided for controlling the light source outputted to the semiconductor laser driver circuit 100.

It is noted that FIG. 2 shows an example of inputting the vertical synchronization signal Vsync having a cycle T1 of 60 Hz.

The modulation signal generator circuit 105 generates the control signal Sc1 for controlling the light to be turned on and off, and the timing signal St indicating the timing for superimposing the communication modulation signal, based on the video signal Svideo and the vertical synchronization signal Vsync. Further, the communication modulator 106 generates the control signal Sc2 for controlling the light source to be turned on and off, based on the timing signal St and the communication modulation code Smc. Further, the semiconductor laser driver circuit 100 drives the semiconductor laser 101 according to the control signal Sc2. The wavelength converter element 102 converts the wavelength of the output light from the semiconductor laser 101, and outputs a wavelength-converted light to the light modulator element 103. In response to this, the light modulator element 103 modulates the luminance (or modulates the intensity) of the output light from the wavelength converter element 102 according to the control signal Sc1, and the luminance of the modulated light modulated is emitted onto the screen 110 via the projection lens 104, and the video 111 thereof is projected on the screen 110.

In the subframes (for intervals T11 and T12 of FIG. 2) on which the communication modulation signals are superimposed, the control signal Sc1 for controlling the light to be turned on and off is continuously turned on for the superimposition intervals T21 and T22. Then, by superimposing the communication modulation signal on the control signal Sc2 for the superimposition intervals T21 and T22, the modulation signal corresponding to the luminance modulation for communication is superimposed for the superimposition intervals T21 and T22 in the subframes, and the luminance-modulated video 111 is emitted onto the screen 110. By capturing the projected video 111 with the camera such as the smart phone described above, it becomes possible to receive information superimposed by a predetermined visible light communication method.

In this case, the superimposition intervals T21 and T22 in the timing signal St of FIG. 2 correspond to the continuous ON intervals of the control signal Sc1. The intervals before and after the continuous ON interval are intervals in which the control signal Sc1 for controlling the light to be turned on and off is modulated according to the video signal Svideo.

The subframe on which the communication modulation signal is superimposed is a subframe that is turned on continuously for a long time, and has greater luminance than other subframes. Therefore, when the subframe is used as a single subframe by itself, the luminance for the interval in which the subframe is turned on increases locally for the interval of the vertical synchronization signal Vsync, which causes a large change in the luminance for each interval of the vertical synchronization signal Vsync.

The strength with which the human eyes perceive flicker changes depending on the frequency of the flicker, and a detection limit of the flicker is as follows:

(A) the detection limit is about 30% of the average luminance when the amplitude of the component to be changed has a frequency of 60 Hz;

(B) the detection limit is about 10% of the average luminance when the amplitude of the component to be changed has a frequency of 50 Hz; and

(C) when the amplitude of the component to be changed has a frequency of 100 Hz or higher, the flicker cannot be detected.

Based on the above contents, in the present embodiment, the subframes T11 and T12 on which the communication modulation signals are superimposed are provided twice for one interval of the vertical synchronization signal (in the modified embodiment, they may be provided multiple times of three or more). Then, the subframes are arranged at equal intervals, and the output light is turned on and off for the same subframes. Further, in the control signal Sc2, the ratio of ON to OFF for the respective intervals of the subframes on which the communication modulation signals are superimposed is set to be constant irrespective of the superimposed information.

FIG. 2 shows an example in which the input frequency is 60 Hz and the number of subframes on which the communication modulation signals are superimposed is two for one interval of the vertical synchronization signal. In this example, the frequency of the repetition cycle T2 is set to 120 Hz for the subframes on which the communication modulation signals are superimposed. Therefore, the person viewing the video using that subframe does not detect any flicker that occurs due to the deviation of the luminance on the time axis in that subfield.

### 1-3. Advantageous Effects and Others

As described above, in the present embodiment, the projector light source modulation apparatus of the present invention provides the integer number of subframes on which the communication modulation signals are superimposed for one interval of the vertical synchronization signal. Then, the subframes are arranged at equal intervals, and are turned on and off simultaneously. As a result, the repetition cycle of the subframes on which the communication modulation signals are superimposed becomes the integer times, and the person viewing the video using the subframe does not detect any flicker that occurs due to the deviation of the luminance on the time axis in that subfield.

Further, in the present embodiment, the ratio of ON to OFF in the interval of the subframe on which the communication modulation signal is superimposed can be arbitrarily set. When the ON ratio is set to be relatively large, it becomes possible to increase the ratio of the ON interval for the signal for controlling the light to be turned on and off in all the subfields, and increase the luminance of the projector. Also, when the ON ratio is set to be relatively small, the luminance of the projector can be reduced. However, the ON interval of the subframe on which the communication modulation signal is superimposed becomes relatively small, and then, the light output becomes relatively small when the subframe on which the communication modulation signal is superimposed is turned on. Accordingly, even if the display video is dark, it becomes possible to turn ON the subframe on which the communication modulation signal is superimposed, and make the ratio of the video on which the communication modulation signal can be superimposed large.

Therefore, when the video displayed is bright, the ratio of the ON interval of the signal to be controlled to be turned on and off is set to be relatively large. When the video displayed is dark, the ratio of the ON interval is set small. Then, the modulation signal generator circuit 105 grasps the ratio and corrects the signal for controlling the light to be turned on and off, and it is possible to stably superimpose the information on the projected video without generating any flicker regardless of the luminance of the input video.

### OTHER EMBODIMENTS

As described above, the first embodiment is described as an example of the technique disclosed in the present application. However, the technique of the present disclosure is not limited to this, and is also applicable to embodiments in which changes, replacements, additions, omissions, and the others are appropriately made. Further, the constituent elements described in the above-described first embodiment can be combined to form new embodiments. Therefore, the other embodiments are described below.

The embodiment uses the output light from the semiconductor laser 101 converted by the wavelength converter element 102. However, the present disclosure is not limited to this, and such a configuration can be made that the semiconductor laser 101 that can emit red, blue, and green light is used without using the wavelength converter element 102.

As described above, the embodiments are described as examples of the technique of the present disclosure. To that end, the accompanying drawings and detailed description are provided.

Therefore, among the constituent elements described in the accompanying drawings and the detailed description, not only the constituent elements that are essential for solving the problems, but also the constituent elements that are not essential for solving the problems may also be included in order to illustrate the above technique. Therefore, it should not be immediately acknowledged that the above non-essential constituent elements are essential based on the fact that the non-essential constituent elements are described in the accompanying drawings and the detailed description.

Further, because the above-described embodiments are for exemplifying the technique of the present disclosure, various changes, replacements, additions, omissions, and the others can be made within the scope of the claims or the scope of equivalents thereof.

The present disclosure can be applied to an apparatus that can associate video displayed by a projector with information transmitted, by superimposing the information on the projected video by performing light source luminance modulation on the projector that projects the video, and by reading the information using an instrument equipped with a camera that images the video.

What is claimed is:

1. A projector light source modulation apparatus, comprising:
a modulation signal generator circuit, that generates a first control signal for controlling light to be turned on and off, and a timing signal indicating a timing of superimposing a communication modulation signal on the video signal, based on a video signal and a vertical synchronization signal;
a communication modulator, that generates a second control signal for controlling a light source to be turned on and off based on the timing signal and a communication modulation code;
a semiconductor laser that generates output light;
a semiconductor laser driver circuit, that drives the semiconductor laser according to the second control signal;
a wavelength converter element, that converts a wavelength of the output light from the semiconductor laser, and outputs a converted light;
a light modulator element, that modulates the light outputted from the wavelength converter element according to the first control signal, and outputs a modulated light; and
a projection lens that projects the modulated light from the light modulator element,
wherein subframes are provided multiple times and arranged temporally at equal intervals for one interval of the vertical synchronization signal, each of the subframes turning on the light modulator element continuously for a superimposition interval of superimposing the communication modulation signal.

2. A projector light source modulation method for a projector light source modulation apparatus, the projector light source modulation apparatus comprising:
a modulation signal generator circuit, that generates a first control signal for controlling light to be turned on and off, and a timing signal indicating a timing of superimposing a communication modulation signal on the video signal, based on a video signal and a vertical synchronization signal;
a communication modulator, that generates a second control signal for controlling a light source to be turned on and off based on the timing signal and a communication modulation code;
a semiconductor laser that generates output light;
a semiconductor laser driver circuit, that drives the semiconductor laser according to the second control signal;
a wavelength converter element, that converts a wavelength of the output light from the semiconductor laser, and outputs a converted light;
a light modulator element, that modulates the light outputted from the wavelength converter element according to the first control signal, and outputs a modulated light; and
a projection lens that projects the modulated light from the light modulator element,
wherein the method includes a step of:
providing subframes multiple times, and arranging temporally at equal intervals for one interval of the vertical synchronization signal, each of the subframes turning on the light modulator element continuously for a superimposition interval of superimposing the communication modulation signal.
